(19) United States
(12) Patent Application Publication
(10) Pub. No.: US 2007/0293593 A1
(43) Pub. Date: Dec. 20, 2007

(54) Low density polylactic acid polymeric foam and articles made thereof

(76) Inventor: Walter R. Harfmann, Weddington, NC (US)

Correspondence Address: KENYON & KENYON LLP, ONE BROADWAY, NEW YORK, NY, 10004, US

(21) Appl. No.: 11/810,340

(22) Filed: Jun. 4, 2007

Related U.S. Application Data
(60) Provisional application No. 60/811,009, filed on Jun. 6, 2006.

(51) Int. Cl. C08J 9/00

(52) U.S. Cl. 521/79

(57) ABSTRACT

This invention presents a process whereby thermoplastic polylactic acid polymers foams having the desirable properties for manufacture of thermoformed articles may be made. It has been found that introduction of a dual functional reactive agent into the melt will improve the relevant properties of the melt and thus, the resultant foam. An example of such an agent is pyromellitic di-anhydride, but it is envisioned that a wide number of dual functional reactive agents can be utilized. It has been found that such dual functional reactive agents do not shift crystalline melt point of the material by any appreciable amount. It has been found that, by carefully controlling such a reaction, melt strength can be increased sufficiently to produce stable foam at temperatures above the melt point of the polymer, to permit the production of foamed polylactic acid polymer and product formed therefrom on conventional process equipment.

### CONTINUITY DATA

The present application claims priority to Provisional Application No. 60/811,009, filed on Jun. 9, 2006, the entirety of which is hereby incorporated by reference.

### FIELD OF INVENTION

The present invention generally relates to a method for producing polylactic acid polymeric foam and articles made therefrom.

### BACKGROUND OF INVENTION

Thermoplastic polymer foams have found wide utility in areas such as packaging, insulation, and shock absorption. Inherent properties of these foams such as low thermal conductivity, light weight, and high strength make such materials ideally suited for many applications. Recent emphasis on environmentally friendly and sustainable products has resulted in the development of polylactic acid, among other bio-engineered polymers. Polylactic Acid, a polymer derived from corn, meets the criteria of sustainable, renewable, and biodegradable.

However, this material has several inherent disadvantages in the marketplace. Among these are a high specific gravity (which results in the weight of the manufactured articles, and subsequently cost, to be high). More importantly, the thermal performance of this material is substandard; the fact that the polymer can distort at temperatures as low as 95 degrees F. greatly limits the use of this plastic in most applications, and specifically in disposable food packaging.

A need therefore exists for a polylactic acid polymer that has a reduced material usage per manufactured article while simultaneously exhibiting improved thermal performance. More specifically, a need exists for a foamed polylactic acid polymer that exhibits these properties.

### SUMMARY OF INVENTION

The primary obstacle to producing foam from polylactic acid is the crystalline melt point of the polymer. As process conditions approach this temperature, the melt phase will quickly freeze. This happens at or about 300 degrees F. Unfortunately, at temperatures just above this point, the melt viscosity of the melt phase is too low to sustain foaming by convention means.

Conventional means for preparing foamed polymers, are well known in the art, and require the use of two extruders. The first extruder acts to melt the polymeric resin and mixes the blowing agent into the melt. The second extruder is used as a heat exchanger to cool the melt mixture such that the melt strength is great enough to support a stable foam structure once exiting the die.

When attempting to process polylactic acid by conventional means, the viscosity of the melt is too low to support a stable foam structure even when cooled to a temperature that is virtually at the freezing (crystalline melt) point of the resin and consequently, the foam quickly collapses after exiting the die. Additional cooling below this point will result in a sudden freeze of the melt causing the process to shut down exerting high pressure and drawing high amperage of the secondary extruder drive. The window of operation to prepare foamed polylactic acid is beyond the control means of the process.

To overcome this limitation, it has been found that introduction of a dual functional reactive agent into the melt will improve the relevant properties of the melt and thus, the resultant foam. An example of such an agent is pyromellitic di-anhydride, but it is envisioned that a wide number of dual functional reactive agents can be utilized. Such agents serve to react with two polymer chains and increase viscosity of the mix. While not wishing to be bound by theory, it is believed that such viscosity enhancement is due to interactions per entanglement theory. However, it has been found that such dual functional reactive agents do not shift crystalline melt point of the material by any appreciable amount. It has been found that, by carefully controlling such a reaction, melt strength can be increased sufficiently to produce stable foam at temperatures above the melt point of the polymer, to permit the production of foamed polylactic acid polymer and product formed therefrom on conventional process equipment.

In addition, it has been found that by driving the density of the polylactic acid below 0.5 grams/cubic centimeter, preferably below 0.25 grams/cc, the thermal conductivity of the foam is reduced to the point that as the foam naturally cools, at a minimum, the center of the structure passes through the crystallization temperature at a low enough rate that some crystallization does occur. The resultant foam structure, it has been found, has significantly better thermal performance characteristics than uncrystallized, solid containers made using polylactic acid currently in the market.

Further, due to the low thermal conductivity coefficient achieved through the foaming, it has been found that even when the interior of a product is at or near its distortion point, the outside of the container will remain near ambient conditions and the package will therefore retain its integrity and not distort.

To achieve the described results, conventional foam extrusion technology is utilized. However, reaction kinetics are insufficient to properly react the agent with the polymer, so significant changes in operating conditions must be implemented.

### DETAILED DESCRIPTION OF INVENTION

In the production of the polylactic acid resin foams the present invention, extruders are used. Thermoplastic polylactic acid resins are melted under an elevated pressure in the extruders and the molten resins are extruded through die into a low-pressure zone to produce foams.

In the production of the polylactic acid resin foams of the present invention, dual functional reactive agents are added to the resins to improve the relevant properties of the melt and thus, the resultant foam. This is achieved by the reaction of the gent with two polymer chains and increase viscosity of the mix, thereby improving the viscoelastic properties of the thermoplastic polylactic acid resins during extrusion, whereby gasified blowing agents can be retained in the interiors of closed cells and uniformly dispersed fine cells can be formed using extruders.

In the present invention, a blend of a thermoplastic polylactic acid resin and a dual functional reactive agent is molten in an extruder, a blowing agent is generally injected into the molten blend and the resulting molten blend is extruded through the die of the extruder for foaming into a low-pressure zone to produce a foam. Alternatively, the dual functional reactive agent and blowing agent can be added simultaneously with the extrusion.

Any of the aromatic acid anhydrides, cyclic aliphatic acid anhydrides, fatty acid anhydrides, halogenated acid anhydrides, etc. can be used as the dual functional reactive agent, so long as they have at least two acid anhydride groups per molecule. Further, mixtures thereof and modified compounds thereof can be used. Preferred examples of the compounds include pyromellitic dianhydride, benzophenonetetracarboxylic dianhydride, cyclopentanetetracarboxylic dianhydride, diphenyl sulfone tetracarboxylic dianhydride and 5-(2,5-dioxotetrahydro-3-furanyl)-3-methyl-3-cyclohexen-1,2-dicarboxylic dianhydride. Among them, pyromellitic dianhydride is more preferred.

The dual functional reactive agent are used in an amount of preferably 0.25-1.0 parts by weight per 100 parts by weight, more preferably 0.25-0.50 parts by weight per 100 parts by weight of the thermoplastic polylactic acid resin. More preferably the amount is 0.25-0.50 parts by weight per 100 parts by weight of the thermoplastic polylactic acid resin.

A large variety of dissolved gaseous agents, also called blowing agents, can be used in the production of the thermoplastic polylactic acid resin foams of the present invention, so long as they are easily vaporizable liquids or thermally decomposable chemicals. Easy vaporizable blowing agents such as inert gases, saturated aliphatic hydrocarbons, saturated alicyclic hydrocarbons, aromatic hydrocarbons, halogenated hydrocarbons, ethers and ketones are preferred. Examples of these easy vaporizable blowing agents include carbon dioxide, nitrogen, methane, ethane, propane, butane, pentane, hexane, methylpentane, dimethylbutane, methylcyclopropane, cyclopentane, cyclohexane, methylcyclopentane, ethylcyclobutane, 1,1,2-trimethylcyclopropane, trichloromonofluoromethane, dichlorodifluoromethane, monochlorodifluoromethane, trichlorotrifluoroethane, dichlorotetrafluoroethane, dichlorotrifluoroethane, monochlorodifluoroethane, tetrafluoroethane, dimethyl ether, 2-ethoxy, acetone, methyl ethyl ketone, acetylacetone dichlorotetrafluoroethane, monochlcrotetrafluoroethane, dichloromonofluoroethane and difluoroethane. Also suitable are thermally decomposable materials such as azodcarbonamide, dinitropentamethylenetetramine, hydrazocarbonamide, and sodium hydrogencarbonate.

Usually, the blowing agent is injected into the molten blend of the thermoplastic polylactic acid resin, along with the compound having two or more acid anhydride groups per molecule and other additives, prior to the extruder. The amount of the blowing agent to be injected is from 1.0-5.0 by weight based on the amount of the molten blend. The preferred amount of the blowing agent is 1.3 percent by weight based on the amount of the molten blend.

In the production of the thermoplastic polylactic acid resin foams of the present invention, stabilizer, expansion nucleating agent, pigment, filler, flame retarder and antistatic agent may be optionally added to the resin blend to improve the physical properties of the thermoplastic polylactic acid resin foams and molded articles thereof. Such agents are well known in the art

In the production of the thermoplastic polylactic acid resin foams of the present invention, foaming can be carried out by any of blow molding process and extrusion process using single screw extruder, multiple screw extruder and tandem extruder.

In the production of the polylactic acid resin foams of the present invention, the dual functional reactive agent thermoplastic polylactic acid resin can be mixed with the thermoplastic resin and other additives by any of the following methods.
(A) The thermoplastic resin is mixed with the compound dual functional reactive agent at a low temperature (e.g., a temperature below the melting point of the thermoplastic resin).
(B) The dual functional reactive agent is previously melt-mixed with a thermoplastic resin, the mixture is pelletized and the pellet is mixed with the thermoplastic polylactic acid resin (this thermoplastic resin may be the same as or different from the thermoplastic polylactic acid resin, but is preferably one compatible with the thermoplastic polylactic acid resin).
(C) The thermoplastic polylactic acid resin is previously fed to an extruder hopper to melt it and the dual functional reactive agent is fed through a feed opening provided at the cylinder of the extruder to effect mixing.

When the pre-expanded foam is cooled, it may crystallize so that thermoforming such material into useful articles becomes impossible. The crystallized material will, upon thermoforming, retain the memory of the crystallized shape and consequently distort at low temperatures. The crystallinity varies depending on the degree of cooling. For example, the crystallinity varies depending on the type and temperature of cooling media and the contact conditions of the foam with the cooling media. In order to conduct effectively the cooling of the pre-expanded foam, it is desirable that the foam has a large surface area in comparison with its volume. Namely, it is desirable that the foam is in the form of a sheet, if possible and its thickness is not more than 10 mm, preferably not more than 3 mm. When the sheet is cylindrical, a mandrel is put into the inside of the cylinder, the sheet is allowed to proceed along the mandrel which is cooled with water and the length of the mandrel should be as long as possible. On the other hand, when the sheet is a flat sheet, the sheet is put between a pair of rollers and allowed to proceed while cooling and at the same time, the rollers are cooled with water and the diameters of rollers should be as large as possible.

The foam sheets can then be thermoformed into useful articles as may be desired by thermoforming techniques which are well known in the art. The thermoformed articles can be used in a variety of applications, but are especially useful in food containers due to the improved thermal performance as compared with non-foamed PLA solid containers.

### EXAMPLES

The following examples illustrates certain preferred embodiments of the instant invention, but is not intended to be illustrative of all embodiments.

### Example 1

### Comparison of Properties for the Foamed Polymer Produced With and Without the Dual Functional Reactive Material

In this example, foamed polylactic acid polymer was prepared under nearly identical conditions (as set forth in Table 1), except that Sample 2 contained a multifunctional additive, specifically Cesa-Extend 1588 manufactured by the Clariant Corporation. The resultant foamed polymers had the Presented in Table 2.

TABLE 1

| | | | Sample | Sample |
|---|---|---|---|---|
| | Time | Units | 1 | 2 |
| Z1 | Primary Zone 1 | C | 200 | 200 |
| Z2 | Primary Zone 2 | C | 203 | 203 |
| Z3 | Primary Zone 3 | C | 220 | 220 |
| Z4 | Primary Zone 4 | C | 218 | 219 |
| Z5 | Primary Zone 5 | C | 221 | 222 |
| Z7 | Screen Changer Inlet Adaptor | C | 205 | 205 |
| Z8 | Screen Changer Body | C | 205 | 205 |
| Z9 | Screen Changer Outlet Adaptor | C | 205 | 205 |
| Z10 | Coupling Elbow | C | 205 | 205 |
| Z11 | Coupling Zone 1 | C | 205 | 205 |
| Z13 | Coupling Zone 2 | C | 205 | 205 |
| Z14 | Secondary Seal Zone 1 | C | 58 | 65 |
| Z15 | Secondary Seal Zone 2 | C | 155 | 153 |
| Z16 | Secondary Zone 1 | C | 138 | 133 |
| Z17 | Secondary Zone 2 | C | 133 | 133 |
| Z18 | Secondary Zone 3 | C | 133 | 134 |
| Z19 | Secondary Zone 4 | C | 133 | 133 |
| Z20 | Secondary Zone 5 | C | 136 | 132 |
| Z21 | Secondary Zone 6 | C | 133 | 133 |
| | Die | C | 154 | 154 |
| Z22 | Mandrel Nose | C | x | 56 |
| Z23 | Mandrel Body 1 | C | x | 56 |
| | Die Melt | C | 160 | 163 |
| | Butane Pump | psia | 3100 | 2250 |
| | Prior to Injection | psia | 2100 | 1095 |
| | Primary Exit | psia | 3815 | 3075 |
| | Die | psia | 1915 | 1730 |
| | Primary Speed | rpm | 93 | 80 |
| | Primary Torque | amps | 161 | 158 |
| | Secondary Speed | rpm | 10.6 | 9.1 |
| | Secondary Torque | amps | 80 | 127 |
| | PLA | kg/hr | 330 | 330 |
| | Regrind | kg/hr | 0 | 0 |
| | Nucleator | kg/hr | 1.3 | 1.2 |
| | Cesa-Extend 1588 | kg/hr | 0 | 0.82 |
| | Butane | kg/hr | 11 | 8.5 |

TABLE 2

| Sample | Density (g/cc) | Cell Size (mm) | Comments |
|---|---|---|---|
| 1 | >1 | indeterminate | material had some voids |
| | | | structure; unable to |
| | | | produce sheet. |
| 2 | 0.3 | 0.5 | consistent foam structure; |
| | | | produced smooth, consistent |
| | | | sheet. |

As seen, when Sample 1 was run, cooling conditions were run that almost resulted in freezing of the material. No additional melt strength could be realized by thermal manipulation. At this condition of maximum cooling, the foam had insufficient melt strength to retain the blowing agent and within seconds of exiting the die would collapse forming plastic “patties” on the floor. No stable cell structure was obtained and any reduction in specific gravity was purely a function of “voids” formed during the collapsing process. The extrudate had insufficient melt strength to stretch over the sizing mandrel to produce sheet.

With Sample 2 was run with the addition of the dual functional reactive additive, Cesa-Extend 1588, was included in the extrusion process at an additive level of 0.25% of the total feed rate. Increase in melt strength was evidenced immediately upon one full residence period of the process (about 20 minutes). The increase was observed visually in the extrudate as well as in process conditions as the amperage of the secondary drive increased from 80 amps to 127 amps. It is known in the art that the secondary extruder drive amps are a direct reflection of the viscosity and melt strength of the material being processed. In this particular case, the extrudate was stretched over the sizing mandrel with no problems and pulled to the winder. Sheet was successfully produced at a specific gravity that is expected for the amount of blowing agent fed to the mixture. This sheet was later thermoformed using equipment well known in the art and designed for production of polystyrene foam articles. With minor heat and cycle speed adjustments, useful articles were formed.

Thus it can be seen that the addition of a dual functional reactive agent into the melt resulted in a foamed polylactic acid polymer of desirable properties for the formation of extruded articles.

### Example 2

### Thermal Performance of Foamed Polylactic Acid

This example illustrates the improvement in thermal performance attained through production of reduced density articles according to the methods of this invention. In this example, a bowl (made from PLA polymer foam produced by the methods of this invention) approximately 9 inches long by 6 inches wide by 2 inches deep was filled to a level of 1 inch deep with water. The specific gravity of the container was 0.4 grams per cubic centimeter. The water is used to simulate an aqueous food. The water was gradually heated and observations were made. This data is presented in Table 3.

TABLE 3

| Interior Temperature | Exterior Temperature | | |
|---|---|---|---|
| (F.) | (F.) | Distortion | Feel |
| 74 | * | No | Firm |
| 94 | * | No | Firm |
| 106 | * | No | Firm |
| 111 | * | No | Firm |
| 118 | * | No | Firm |
| 122 | * | No | Firm |
| 127 | 106 | No | Firm |
| 134 | 105 | No | Firm |
| 140 | 120 | No | Soft |
| 148 | 123 | Yes | Soft |

* Not measured

It can be seen that the thermal conductivity improvement of the foam keeps the exterior of the container significantly lower in temperature than the interior. As a result, the useful temperature range of the product is increased by approximately 20 degrees F., exhibiting a detectable softening at 140 degrees F. while a solid (non foamed) PLA product will deform at or below 120 degrees F.

It is apparent that many modifications and variations of this invention as hereinabove set forth may be made without departing from the spirit and scope thereof. The specific embodiments described are given by way f example only, and the invention is limited only by the terms of the appended claims.

What is claimed is:

1. A method for producing low density, polylactic acid foam comprising:
i. melting a thermoplastic polylactic acid polymer to form a polymer melt;
ii. adding a dual functional reactive agent to the polymer melt;
iii. introducing a gaseous agent into the melted polymer under pressure such that the gaseous agent dissolves becomes soluble in the polymer melt;
iv. extruding said melt containing said dissolved gaseous agent through a cooling extruder at a temperature and rate selected to allow said reactive agent to effectively react with the polylactic acid polymer; and
v. cooling said mixture to increase the melt strength of the polymer phase.

2. The method of claim 1 further comprising thermoforming the low density polylactic acid foam into a useful article.

3. The method of claim 1 wherein the polylactic acid foam has a density less than 0.5 gm/cc.

4. The method of claim 3 where in the polylactic acid foam has a density of less than 0.25 gm/cc.

4. The method of claim 1 wherein the process is conducted using a first extruder to melt the polylactic acid polymer and a second extruder to cool the melt mixture such that a stable polylactic acid polymer foam is produced.

5. The method of claim 1 wherein the dual functional reactive agent is a di-anhydride.

6. The method of claim 5 wherein the dual functional reactive agent is pyromellitic di-anhydride.

7. The method of claim 1 wherein the dissolved gaseous agent is selected from the group consisting of a solid compound which decomposes to generate a gas, a liquid which is vaporized by heating, and an inert gas capable of dissolving in the polymer melt.

8. The method of claim 7 wherein the dissolved gaseous agent is selected from the group consisting of carbon dioxide, nitrogen, methane, ethane, propane, butane, pentane, hexane, methylpentane, dimethylbutane, methylcyclopropane, cyclopentane, cyclohexane, methylcyclopentane, ethylcyclobutane, 1,1,2-trimethylcyclopropane, trichloromonofluoromethane, dichlorodifluoromethane, monochlorodifluoromethane, trichlorotrifluoroethane, dichlorotetrafluoroethane, dichlorotrifluoroethane, monochlorodifluoroethane, tetrafluoroethane, dimethyl ether, 2-ethoxy, acetone, methyl ethyl ketone, acetylacetone dichlorotetrafluoroethane, monochlcrotetrafluoroethane, dichloromonofluoroethane, difluoroethane, azodcarbonamide, dinitropentamethylenetetramine, hydrazocarbonamide, and sodium hydrogencarbonate.

9. The method of claim 1 wherein the dissolved gaseous agent is included at a concentration of about 1.0-5.0 percent by weight.

10. The method of claim 1 wherein the dual functional reactive agent is mixed with the thermoplastic polylactic acid polymer prior to the extruding.

11. The method of claim 1 wherein the dual functional reactive agent is added concurrently with the extruding.

12. The method of claim 11, wherein the dual functional reactive agent is added at a rate of about 0.25% of the extrusion rate.

13. The method of claim 1 wherein the foamed polymer is extruded as a sheet.

14. A thermoformed article produced by the method of claim 2.
